(19) United States
(12) Patent Application Publication
(10) Pub. No.: US 2009/0193357 A1
(43) Pub. Date: Jul. 30, 2009

(54) Method and System to Prevent Unintended Graphical Cursor Input

(76) Inventors: Michael W. Panico, Austin, TX (US); Frank P. Feuerbacher, Austin, TX (US); Rolf Kocheisen, Cedar Park, TX (US); John D. Hannon, Austin, TX (US); Vijayanand Vinnakota, Round Rock, TX (US); Virgil Itliong, Cedar Park, TX (US); Brian David Nelson, Austin, TX (US)

Correspondence Address: MAXVALUEIP CONSULTING LLC, 11204 ALBERMYRTLE ROAD, POTOMAC, MD, 20854, US

(21) Appl. No.: 12/020,528

(22) Filed: Jan. 26, 2008

(51) Int. Cl. G06F 3/048

(52) U.S. Cl. 715/803

(57) ABSTRACT

This is a system (as an example) to prevent an undesirable condition of a second application GUI interface window blocking the first application GUI interface window, while the user's focus is on the first window, and causes an unintended input into a wrong application. This is accomplished (as an example) by temporarily discarding the inputs while the Graphical cursor is located on the 2nd application's GUI interface for a predetermined amount of time and gives the user enough time to refocus on this new application GUI interface.

### BACKGROUND OF THE INVENTION

Personal computer systems typically utilize a Graphical User Interface (GUI) to facilitate the communication of data between the computer and a user. Conventional GUIs permit a plurality of applications to concurrently present graphical components (e.g., windows) to the user. GUIs also allow input through a graphical cursor controlled through an external input device, such as a mouse or a keyboard.

An undesirable condition can occur when an application displays a graphical component on the screen where the border of the component contains the current graphical cursor. Because the GUI can display multiple applications, the user may be attempting to interact with a first application through an external device (such as a mouse) exactly when the second application displays a graphical component. In this case, the user may inadvertently interact with the graphical component of the second application when they meant to interact with the first application.

For example, just as the user is about to click the OK button in this dialog (see FIG. 1), another dialog pops up on top such that the current graphical cursor is over an action button in the new dialog (see FIG. 2). If the user is in the process of clicking the button via a mouse or any other input device when the new dialog appears, the action of the new dialog may be activated accidentally.

One solution for this problem is to not permit applications to overlay in a GUI. One such example of this is called a “tiled interface” because each application occupies its own section (tile) of the screen.

### SUMMARY OF THE INVENTION

This is a system to prevent an undesirable condition of a second application GUI interface window blocking the first application GUI interface window, while the user's focus is on the first window and causes an unintended input into a wrong application (as an embodiment). This is accomplished by temporarily disabling the inputs until the user's attention is focused on the new interface window. This system operates only when a windows display component overlaps another windows component which was the original interface that user was working with. This is accomplished by determining the coordinates of the graphical cursor. If the graphical cursor is not within the boundaries of the new window, normal processing is continued and inputs are accepted.

If the graphical cursor is within the boundaries the new window, the current time is examined and saved as the start time of the process, a visual mask is displayed over the new screen to indicate the inputs are disabled and then any input events to that screen is disabled. At this point the current time is again examined and subtracted from the start time and saved as elapsed time. If elapsed time is greater or equal to the predetermined wait time, mask is removed and inputs are enabled. If elapsed time is not greater or equal to the wait time, elapsed time is continually monitored and updated until the condition is met and inputs are enabled again.

### BRIEF DESCRIPTION OF THE DRAWINGS

FIG. 1 is the application 1 GUI input screen.

FIG. 2 is the application 2 GUI input screen overlapping the first screen.

FIG. 3 is the systems proposed example of changing the looks of second screen with a visual mask while the inputs are disabled.

FIG. 4 is a flow diagram of this system.

FIG. 5 is the continuation of the flow diagram of this system from FIG. 4.

### DETAILED DESCRIPTION OF THE PREFERRED EMBODIMENTS

This is a system and method of prevention of an unintended input into a display which in fact a wrong and unintended application could be activated; this method is comprised of the following steps: (as one embodiment)

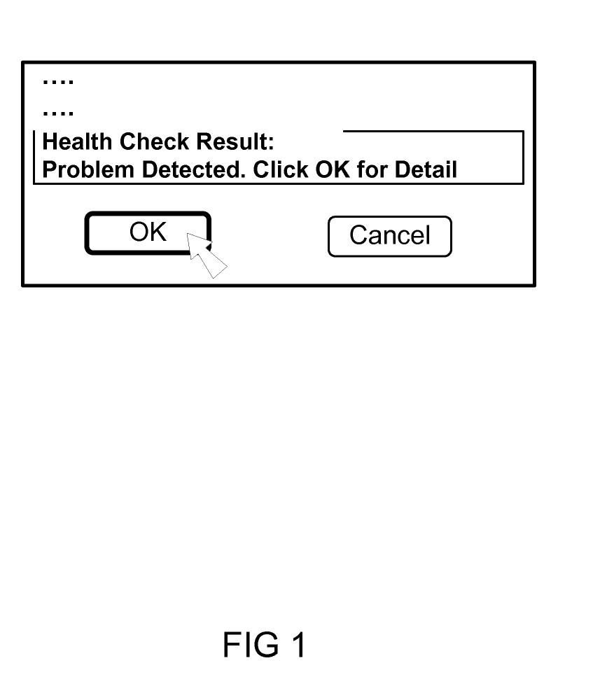

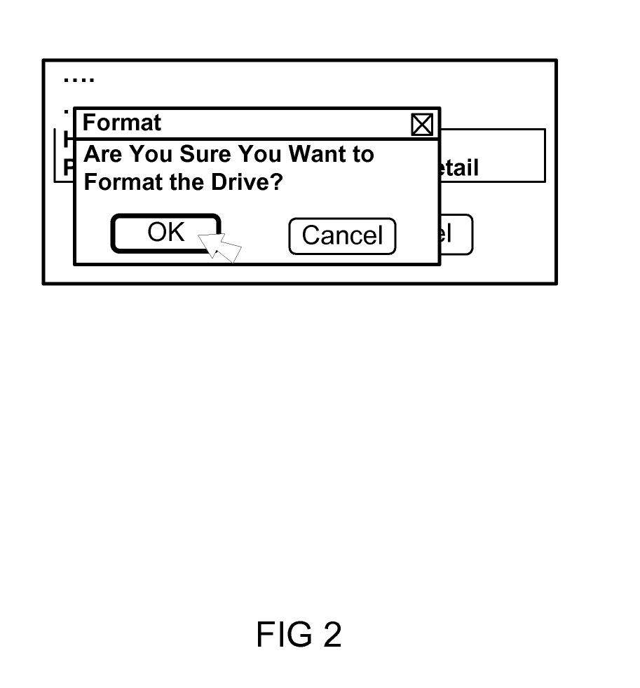

If displaying a first window (FIG. 1) on the display and displaying a second window on the display, if the second window overlapping the first window, (FIG. 2) discarding any events corresponding to the second window for a predetermined amount of time.

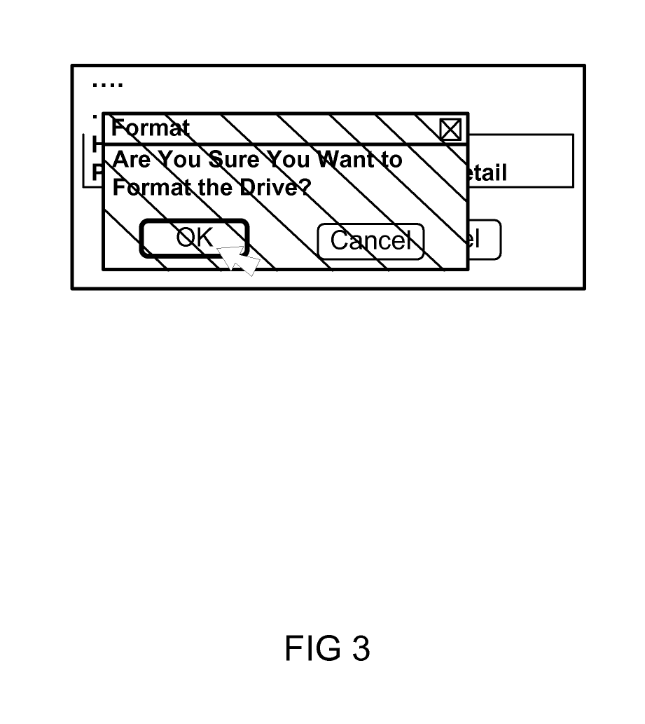

In case of a critical function on the second window: disabling this critical function for a predetermined amount of time, changing the appearance of the second window for a predetermined amount of time, (FIG. 3) and notifying a user about discarding any events corresponding to the second window for a predetermined amount of time, if the user attempts to input at a point on the display, where the coordinate of the point is within a region defined by the second window on the display.

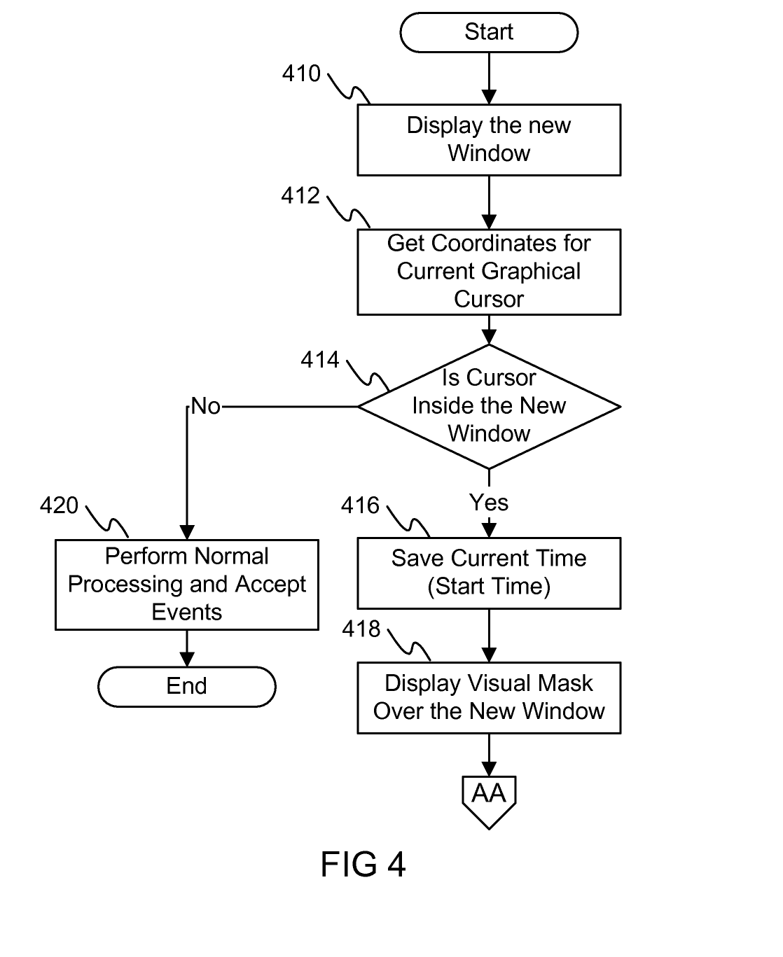

Another embodiment of this system is depicted in FIG. 4. As user tries to input a data or acknowledge a function for an application through its GUI interface screen, another screen belonging to a second application interface is displayed overlapping the first screen notifying the user of another critical function (FIG. 4 step 410). The proposed system collects the coordinates of the graphical cursor at this time in Step 412 of FIG. 4.

If this coordinate indicates that the graphical cursor is not in the new window (FIG. 4 step 414), normal processing will continue (FIG. 4 step 420) and algorithm ends. If this coordinate indicates that the graphical cursor is inside the new window (FIG. 4, step 414), current time is saved as the start time (FIG. 4, step 416) and a visual mask is displayed on the seconds screen (FIG. 4, step 418). An example of a visual mask is displayed in FIG. 3 but this could be any mask with any color and feature as long as causes the user's attention to be refocused on this screen and its intended delivered message.

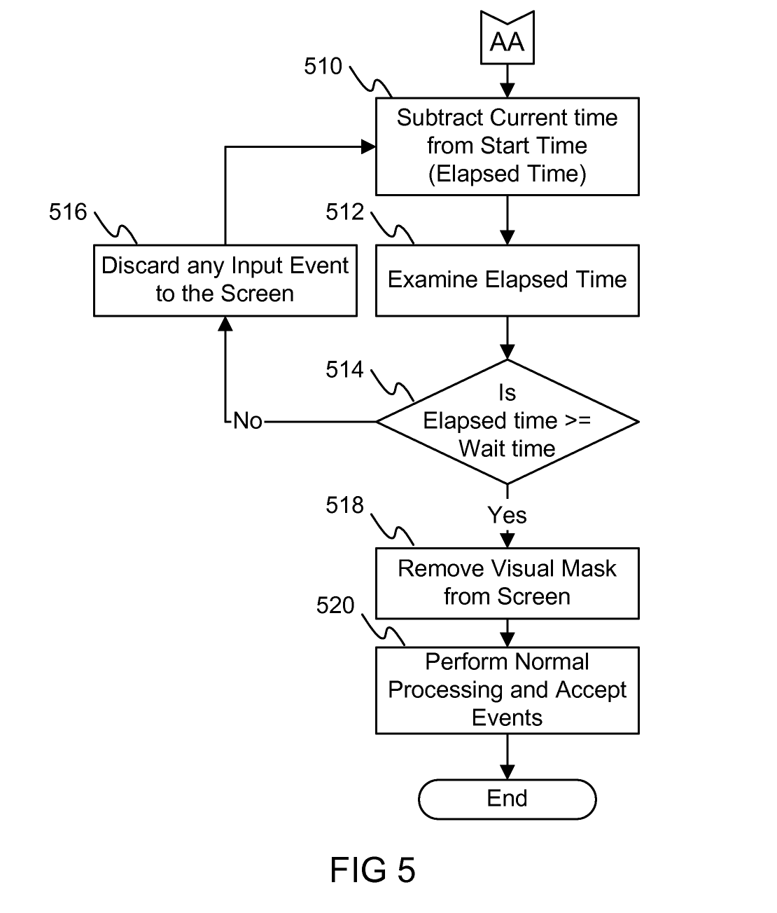

Once the visual mask is displayed on the second screen, the current time is examined and subtracted from the start time and saved as elapsed time (FIG. 5 step 510). At this time the elapsed time is examined (FIG. 5, step 512). If the elapsed time is greater or equal to a predetermined wait time (FIG. 5, step 514), visual mask is removed from the second screen in FIG. 5, step 518, normal processing is resumed and input events are accepted again (FIG. 5, step 520).

If the elapsed time is not greater or equal to the predetermined wait time (FIG. 5, step 514), all the input events to the screen are discarded (FIG. 5 step 516) and current time is again examined to determine the new elapsed time (FIG. 5, step 510). Steps 510, 512, 514 and 516 are repeated until elapsed time is greater or equal to the wait time, which visual mask is removed, normal processing is resumed and input events are accepted.

The term windows is not meant to refer to the Microsoft Window Operating System as it is referred to a GUI interface window on any of the current available operating systems, such as and not limited to UNIX, Linux, and Microsoft Windows.

A system, apparatus, or device comprising one of the following items is an example of the invention: a PC, computer, a device with a GUI, communication device, PDA, server, client device, keyboard, input device, input interface, windows, operating system, or mouse, applying the method mentioned above, for managing cursor or GUI/interface.

Any variations of the above teaching are also intended to be covered by this patent application.

1. A method of prevention of an unintended input into a display, said method comprising:
displaying a first graphical user interface window of a first application on said display;
displaying a second graphical user interface window of a second application on said display;
if said second graphical user interface window overlaps said first graphical user interface window, then
in case of formatting a drive function on said second graphical user interface window, disabling said formatting said drive function for a predetermined amount of time;
changing an appearance of said second graphical user interface window for said predetermined amount of time;
following said changing said appearance of said second graphical user interface window, discarding user input events corresponding to said second graphical user interface window for said predetermined amount of time; and
notifying a user about said discarding said user input events corresponding to said second graphical user interface window, if said user attempts to input at a point on said display, wherein a coordinate of said point is within a region defined by said second graphical user interface window on said display.
